(19) United States
(12) Patent Application Publication
(10) Pub. No.: US 2026/0056423 A1
(43) Pub. Date: Feb. 26, 2026

(54) LENS ASSEMBLY

(71) Applicant: PROHERO GROUP CO., LTD., TAINAN CITY (TW)

(72) Inventor: PEN-WEI CHEN, TAINAN CITY (TW)

(21) Appl. No.: 18/809,549

(22) Filed: Aug. 20, 2024

(51) Int. Cl. G02C 5/14

(52) U.S. Cl. CPC G02C 5/146; G02C 2200/06

(57) ABSTRACT

A lens assembly is provided. A locking portion is formed integrally on each of two sides of a lens. The locking portion can be either mounted and connected to a temple correspondingly or directly mounted to and fixed on a frame in a front direction of the frame. Thereby the assembly of the lens with the temples becomes easier and more conveniently. Users can also select the way of assembly according to their needs. Therefore, the purposes of convenient assembly and better stability are achieved.

### BACKGROUND OF THE INVENTION

### Field of the Invention

The present invention relates to a lens assembly, especially to a lens assembly in which a lens is directly mounted to temples.

### Description of Related Art

Generally, conventional eyeglasses include a frame, lenses, a bridge, temples, etc. The lenses not only provide different functions such as optical degrees, UV protection, and eye protection, but also have different colors for better appearance and texture.

The frame can be a full frame or a half frame. When the frame is a full frame, it is provided with a mounting hole in which a lens is able to be fitted and held. When the frame is a half frame, it is provided with mounting slot in which an upper edge of a lens can be mounted. Thus the lens and the frame are connected to and positioned by each other. However, the lens locked by such way is easy to get loose and fall off. Thereby bolts are further used for fixing after the lens and the frame being assembled. The fitting or mounting of the lens into the frame is easy and convenient but there is still a problem of poor stability of the assembly. The lens is easy to be released from the frame once being applied with a force while users wearing an assembly of the lens with the frame. Although the connection by the bolts provides better stability of the assembly, tools are required for threading process. Thus the assembly and the replacement of the lens are inconvenient.

Nowadays an eyewear assembly is designed to make users feel more comfortable while wearing the eyewear and replacement of components become more convenient. Thereby manufacturers are dedicated to improve the components of the eyewear and make the eyewear more convenient to use and more comfortable to wear.

Thus there is room for improvement and there is a need to provide a lens assembly which is more convenient to use.

### SUMMARY OF THE INVENTION

Therefore, it is a primary object of the present invention to provide a lens assembly in which a lens can be directly mounted and connected to temples. Thus the lens assembly is convenient to be assembled.

In order to achieve the above object, a lens assembly according to the present invention includes a lens combined with temples or a frame.

A locking portion is formed integrally on each of two sides of the lens. The locking portion can be either mounted and connected to the temple correspondingly or directly mounted to and fixed on the frame in a front direction of the frame. Thereby the assembly of the lens with the temples becomes easier and more conveniently. Users can also select the assembly way according to their needs. The purposes of convenient assembly and better stability are achieved.

Preferably, the lens is a one-piece or two-piece lens provided with an integrally-formed bridge portion.

Preferably, the locking portion of the lens is arranged at an upper half or a middle portion on the side of the lens.

Preferably, one end of each of the temples is provided with a connection portion and a first mounting slot is arranged at the connection portion and located at a position corresponding to the locking portion. The locking portion and the first mounting slot can be locked and positioned by each other.

Preferably, the frame consists of an upper-edge portion and two side-edge portions, each of which is provided with a second mounting slot corresponding to the locking portion. The locking portion and the second mounting slot are able to be locked and positioned by each other.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded view of an embodiment according to the present invention;

FIG. 2 is an exploded view of a section of an embodiment according to the present invention;

FIG. 3 is a sectional view of an embodiment according to the present invention;

FIG. 4 is a perspective view showing a position of a locking portion of an embodiment according to the present invention;

FIG. 5 is a schematic drawing showing another type of lens of an embodiment according to the present invention;

FIG. 6 is an exploded view of another embodiment according to the present invention;

FIG. 7 is a perspective view of another embodiment according to the present invention;

FIG. 8 is a schematic drawing showing a lens flush with an upper-edge portion of a frame of an embodiment according to the present invention.

### DETAILED DESCRIPTION OF THE PREFERRED

### Embodiment

In order to learn technical content, features, and functions of the present invention more clearly and completely, please refer to the following embodiments with related figures and reference signs.

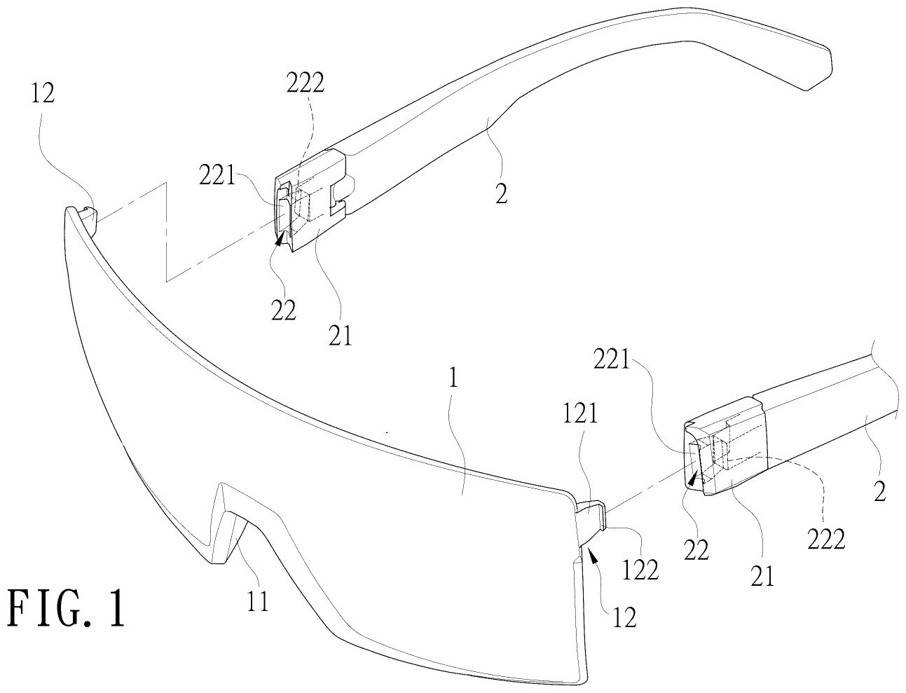

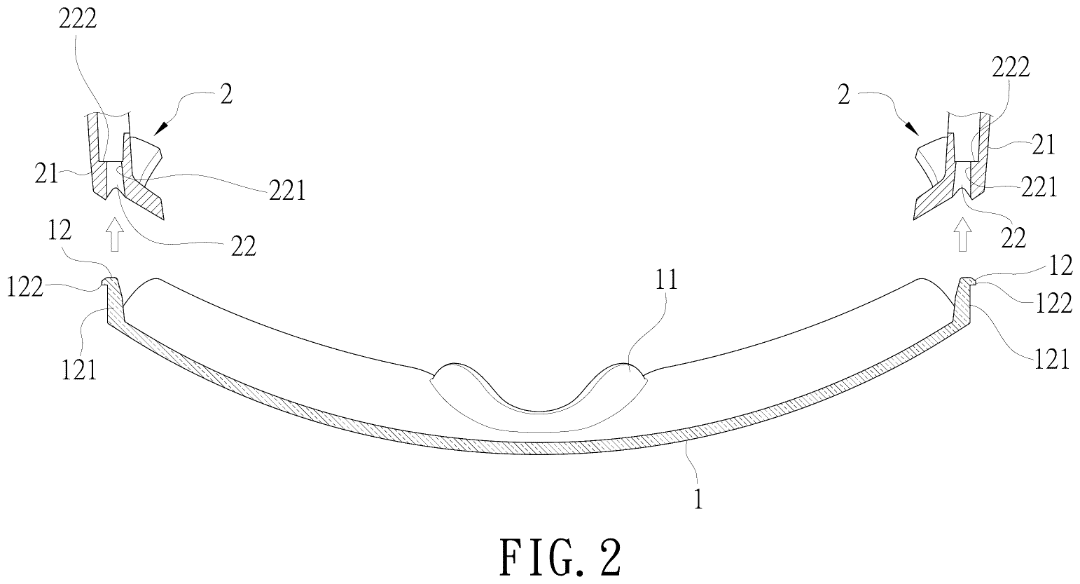

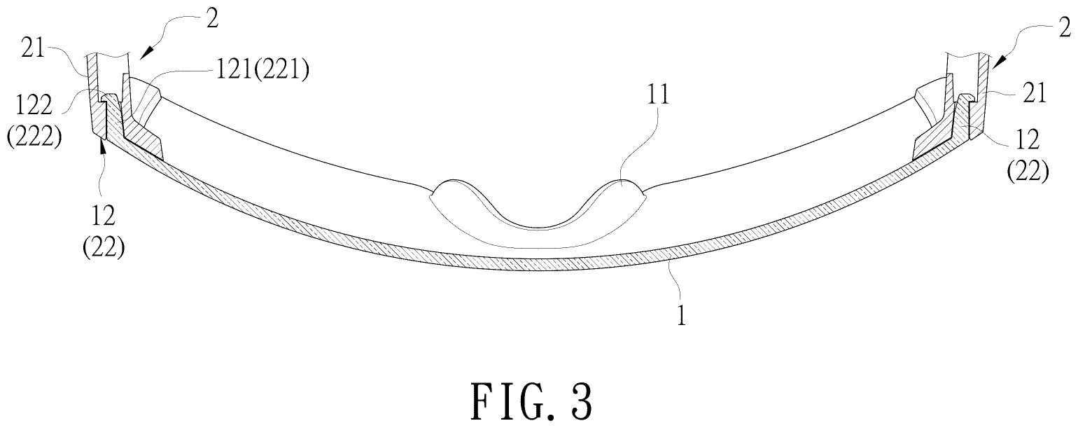

Refer to FIG. 1, FIG. 2, and FIG. 3, a lens assembly according to the present invention mainly includes a lens 1 and two temples 2.

The lens 1 is provided with a bridge portion 11 located at a middle part of the lens 1 and a locking portion 12 formed integrally on each of two sides of the lens 1.

The two temples 2 are disposed on the two sides of the lens 1 correspondingly and a front end of each of the temples 2 is provided with a connection portion 21 and a first mounting slot 22 which is arranged at the connection portion 21 and located at a position corresponding to the locking portion 12. The locking portion 12 and the first mounting slot 22 are able to be locked and positioned by each other.

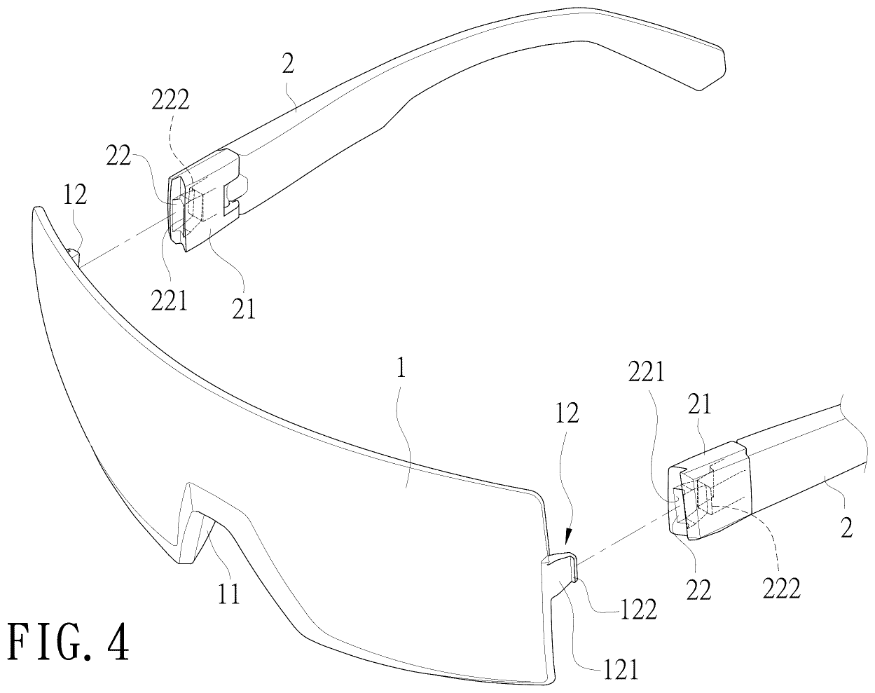

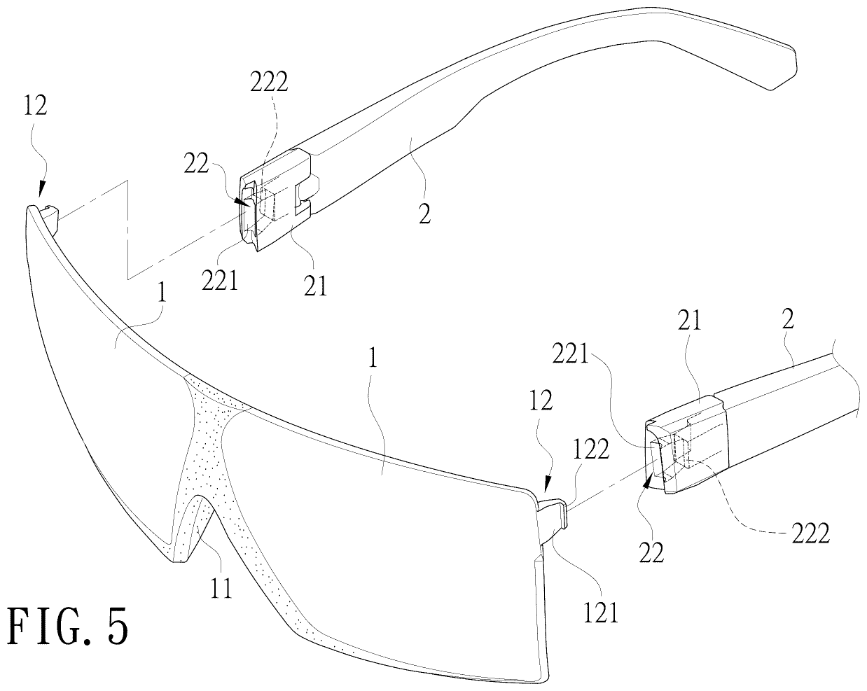

As shown in FIG. 1-4, the lens 1 is a one-piece or two-piece lens (as shown in FIG. 5) provided with an integrally-formed bridge portion 11. In the two-piece lens design, a connection way of left lens and right lens is not limited. The left and right lenses can be connected by the bridge portion 11 or by an upper frame and a lower frame. While being assembled, the locking portions 12 on the two sides of the lens 1 are aligned with the first mounting slots 22 on the connection portions 21 of the two temples 2 correspondingly and then the locking portions 12 are mounted into the first mounting slots 22 directly to complete the assembly of the lens 1 easily and conveniently. The locking portion 12 of the lens 1 can be disposed on an upper half (as shown in FIG. 1) or a middle portion (as shown in FIG. 4) on the side of the lens 1. The position of the locking portion 12 can be changed according to users'needs or the design of the temple 2.

Moreover, the locking portion 12 mainly includes a rod portion 121 integrated with an outer side of the lens 1 and a hook portion 122 extending from the rod portion 121. As to the first mounting slots 22, it is provided with a first straight slot portion 221 corresponding to the rod portion 121 and a first step-like portion 222 formed at a rear end of the first straight slot portion 221 and used for being locked with the hook portion 122.

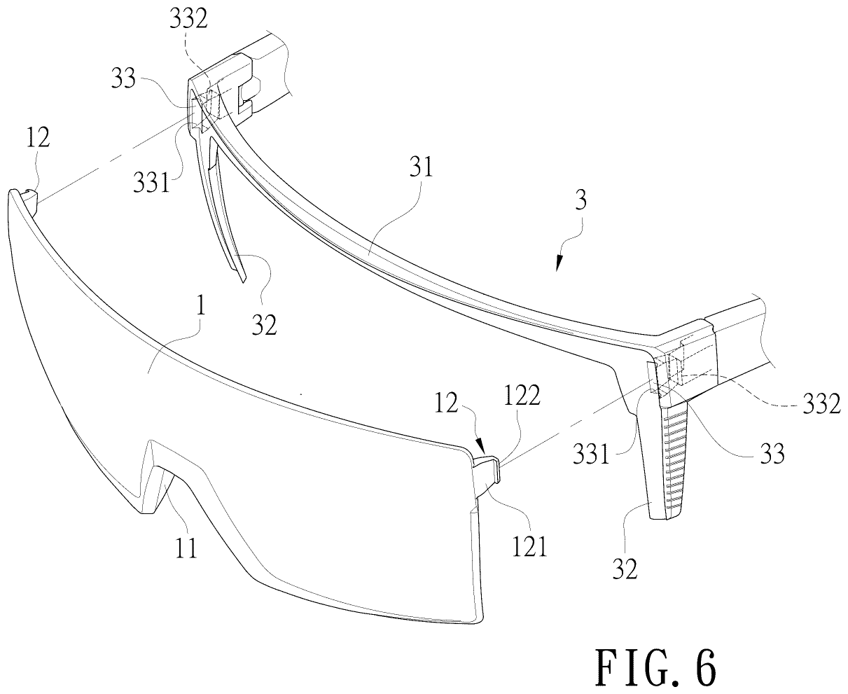

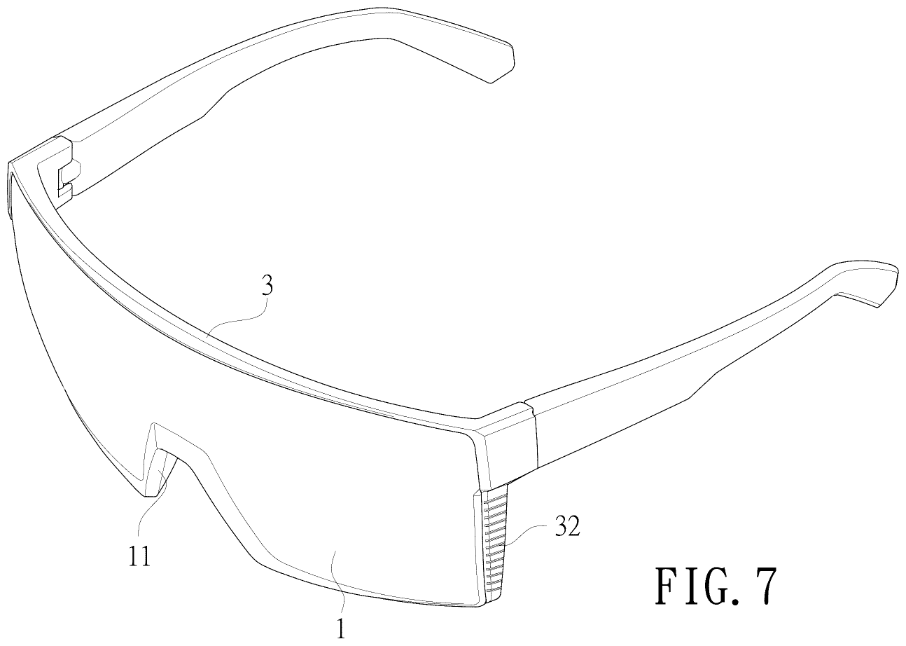

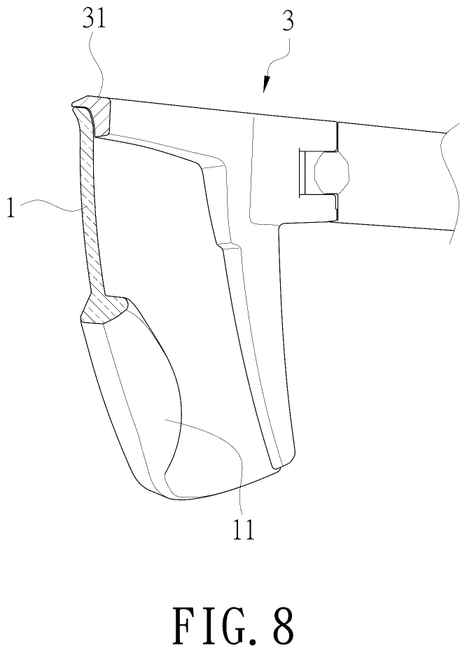

Refer to FIG. 6, FIG. 7, and FIG. 8, another embodiment of the present invention is provided. In this embodiment, besides being directly assembled with the temples 2, the lens 1 can also be set on a frame 3. A lens assembly of the present invention includes a lens 1 and a frame 3.

The lens 1 is provided with a bridge portion 11 disposed on a middle part of the lens 1 and a locking portion 12 formed integrally on each of two sides of the lens 1.

The frame 3 consists of an upper-edge portion 31 and two side-edge portions 32, each of which is provided with a second mounting slot 33 corresponding to the locking portion 12. The locking portion 12 and the second mounting slot 33 are able to be locked and positioned by each other.

While being assembled, the lens 1 is directly mounted to the frame 3 in a front direction of the frame 3. The locking portion 12 on the two sides of the lens 1 are aligned with the second mounting slots 33 on the side-edge portions 32 of the frame 3 and directly mounted into the second mounting slots 33 correspondingly. Thus the lens 1 is disposed on the frame 3 easily. The side-edge portions 32 of the frame 3 can be further pivotally connected with temples 2. After being assembled, the lens 1 is mounted to the upper-edge portion 31 and the side-edge portions 32 of the frame 3, and flush with the upper-edge portion 31 and the side-edge portions 32 of the frame 3, so that users will not have a feeling of heaviness due to thickness of a periphery of the frame 3 and an aesthetic appearance is achieved.

In this embodiment, the locking portion 12 mainly includes a rod portion 121 integrated with an outer side of the lens 1 and a hook portion 122 extending from the rod portion 121. The second mounting slot 33 is provided with a second straight slot portion 331 corresponding to the rod portion 121 and a second step-like portion 332 formed at a rear end of the second straight slot portion 331 and used for being locked with the hook portion 122.

In summary, the present invention has the following advantages compared with the structure available now.
1. The present lens assembly is installed by the locking portion on the lens directly aligned with and mounted into the temples or the frame correspondingly. The assembly process is easy and convenient.
2. The locking portions on the lens directly are aligned with and mounted into the temples or the frame according to user's needs. Thus the users have more options and the lens assembly is convenient to use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A lens assembly comprising:
a lens which is provided with a bridge portion located at a middle part of the lens and a locking portion formed integrally on each of two sides of the lens; and
two temples disposed on two sides of the lens correspondingly and a front end of the respective temples provided with a connection portion; a first mounting slot arranged at the connection portion and corresponding to the locking portion; the locking portion and the first mounting slot able to be locked and positioned by each other.

2. The lens assembly as claimed in claim 1, wherein the locking portion includes a rod portion integrally formed on an outer side of the lens and a hook portion extending from the rod portion; the first mounting slot is provided with a first straight slot portion corresponding to the rod portion and a first step-like portion formed at a rear end of the first straight slot portion and used for being locked with the hook portion.

3. The lens assembly as claimed in claim 1, wherein the locking portion of the lens is arranged at an upper half or a middle portion on the side of the lens.

4. The lens assembly as claimed in claim 2, wherein the locking portion of the lens is arranged at an upper half or a middle portion on the side of the lens.

5. A lens assembly comprising:
a lens provided with a bridge portion arranged at a middle part of the lens and a locking portion formed integrally on each of two sides of the lens; and
a frame having an upper-edge portion and two side-edge portions, each of which is provided with a second mounting slot corresponding to the locking portion; the locking portion and the second mounting slot able to be locked and positioned by each other.

6. The lens assembly as claimed in claim 5, wherein the locking portion includes a rod portion integrally formed on an outer side of the lens and a hook portion extending from the rod portion; the second mounting slot is provided with a second straight slot portion corresponding to the rod portion and a second step-like portion formed at a rear end of the second straight slot portion and used for being locked with the hook portion.

7. The lens assembly as claimed in claim 5, wherein the lens is flush with the upper-edge portion and the side-edge portions of the frame.

8. The lens assembly as claimed in claim 6, wherein the lens is flush with the upper-edge portion and the side-edge portions of the frame.
